(19) United States
(12) Patent Application Publication
(10) Pub. No.: US 2015/0239685 A1
(43) Pub. Date: Aug. 27, 2015

(54) COMPUTER-IMPLEMENTED CONTAINER TERMINAL MANAGEMENT SYSTEM AND METHOD

(71) Applicants: Sang Yoon Daniel Han, Toronto (CA); Hyeshik Benji Han, Seal Beach, CA (US)

(72) Inventors: Sang Yoon Daniel Han, Toronto (CA); Hyeshik Benji Han, Seal Beach, CA (US)

(73) Assignee: QODEBOX INC, Cheyenne, WY (US)

(21) Appl. No.: 14/191,577

(22) Filed: Feb. 27, 2014

(51) Int. Cl. B65G 63/00

(52) U.S. Cl. CPC B65G 63/004

(57) ABSTRACT

Disclosed is a computer-implemented system for managing a container terminal. The system comprises a database listing the plurality of identified shipping containers stacked at various identified storage locations within the container terminal, an assignment module for ordering a shipping container to be moved from a staging location to a storage location within a container terminal, the shipping container represented by the identification code thereof, a jockey device for verifying whether or not the shipping container is moved to the ordered storage location, the verification device comprising a scanner for scanning the identification code on a shipping container moved to a storage location assigned thereto, the code scanned at the storage location, and a GPS Receiver for receiving the GPS coordinates thereof during the scanning, and an updation module for, upon successful verification, updating the database accordingly.

### CROSS-REFERENCE TO RELATED APPLICATION

This application claims benefit of priority of U.S. Provisional Patent Application Ser. No. 61/774,313, filed on Mar. 7, 2013, entitled “System and Method for Tracking Containers in a Yard”, owned by the assignee of the present application and herein incorporated by reference in its entirety.

### BACKGROUND

### Field of the Invention

The present invention relates to the management of shipping container terminals and more particularly to a computer-implemented container terminal management system and method that enables to carry out the day-to-day operations of a container terminal at a lower cost by employing everyday gadgets.

A container terminal is an interim storage facility, where shipping containers are generally temporarily stored before being transported to their designated destinations. A container terminal generally consists of one or more staging areas and a regular storage area, wherein, the staging area is where incoming shipping containers are dropped off and outgoing shipping containers await their impending pickup and a storage area is where the shipping containers are categorically stored in stacks, known as, container stacks. While, generally, the staging areas may be marked by randomness and non-particularity, the storage areas, on the other hand, are well organized and maintained.

Yard jockeys are employed at container terminals for running day-to-day operations of a container terminal, which include moving a shipping container by a trailer from a staging area to a specific location in the storage area, moving a shipping container at a specific location in the storage area to the staging location, and relocating a shipping container within the storage area. Upon the completion of an operation, the yard jockey is required to verify or confirm that he/she has ‘successfully’ completed the operation assigned to him/her. This verification is performed by sensor equipment that reads codes, receives location data, measures altitude, etc., and communicates the same with the information system employed by the container terminal. The sensor equipment employed at the container terminals are expensive thus leading to rise in the maintenance costs of the container terminal. Today, with all the technology at one's disposal, there should certainly be a way to overthrow the expensive sensor equipment and replace it with cheaper but efficient substitutes.

### SUMMARY

An embodiment of the present invention comprises a computer-implemented system for managing a container terminal, which is configured to be sensitive to everyday equipment that is employed for carrying out the paramount verification tasks within a container terminal. More particularly, in lieu of the aforementioned expensive sensor equipment, commonplace smartphones equipped with camera and GPS receiver are employed. The camera acts as a sensor for reading the identification of the shipping containers, which are usually encoded, while the GPS receiver verifies whether or not a shipping container is moved to an appropriate location. Further, the system is configured such that, the altitude at which a shipping container is stored (or the level of the shipping container) is determined by keeping track of number of time successful verifications are performed at a storage location. In a simple example, if a shipping container is added to an existing stack of two shipping containers as recorded in a database employed by the system, then the level of the newly-added shipping container is determined to be three thus eliminating the need for employing an altitude sensor.

Other objects and advantages of the embodiments herein will become readily apparent from the following detailed description taken in conjunction with the accompanying drawings.

### BRIEF DESCRIPTION OF THE DRAWINGS

FIG. 1 is a schematic block diagram of the computer-implemented container terminal management system according to an embodiment of the present invention.

FIG. 2 is a schematic block diagram of the registration module according to an embodiment of the present invention.

FIG. 3 is an exemplary screenshot of a registration form according to an embodiment of the present invention.

FIG. 4, according to an embodiment of the present invention, is an exemplary screenshot of the interactive map.

FIG. 5, according to an embodiment of the present invention, is a schematic block diagram of a jockey module.

FIG. 6, according to an embodiment of the present invention, is an exemplary screenshot rendered on a jockey device.

FIG. 7, according to an embodiment of the present invention, is a flowchart depicting the registration process.

FIG. 8, according to an embodiment of the present invention, is a flowchart depicting the operation assignment process.

FIG. 9, according to an embodiment of the present invention, is a flowchart depicting an incoming operation process.

FIG. 10, according to an embodiment of the present invention, is a flowchart depicting an outgoing operation process.

FIG. 11, according to an embodiment of the present invention, is a flowchart depicting a relocation operation process.

Table 1, according to an embodiment of the present invention, depicts an exemplary storage database.

### FIGURES

### Reference Numerals

10—Computer-Implemented Container Terminal Management System
12—Management User Interface
14—Interactive Map
15—Shipping Container
16—Database
18—Registration Module
20—Assignment Module
22—Updation Module
24—Storage Location Database
26—Staging Location Database
28—Radio Communications Network
30—Remote User Terminal
32—Verification Device
34—Registration User Interface
36—Code Generator
38—Jockey User Interface
40—Scanner
42—GPS Receiver
43—Verification Module
44—Registration Form
46—Row
48—Column
50—Level

### DETAILED DESCRIPTION

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

Embodiments of the present invention are directed to a computer-implemented container terminal management system and method wherein, the “container terminal management” involves keeping track of and record for the shipping containers that arrive within the container terminal, keeping track of and record for the shipping containers that are stored within the container terminal, and keeping track of and record for the shipping containers that depart from the container terminal. As mentioned earlier, a container terminal is a location where shipping containers are generally temporarily stored in stacks wherein, the point at which the shipping containers are stacked will be referred as a shipping container storage location hereinafter. A container terminal further comprises a staging location where shipping containers are initially received or await departure.

Generally, the storage locations within a container terminal are formed in a matrix formation whereby, a storage location is referred to by the row and column value thereof exemplarily represented by (r, c) where, ‘r’ represents the row value and ‘c’ represents the column value. For example, the storage location (5, 3) refers to the storage location which is the intersection of the storage locations in the fifth row and the third column within the container terminal. A shipping container within a stack will be referred to by the level value thereof wherein, a level value is a number of the shipping container from bottom. For example, if the level value of a shipping container is three, then it means that the shipping container is third shipping container from bottom or ground. Therefore, a shipping container within a container terminal will be referred to by combining the aforementioned row and column values with the level value. For example, the shipping container (5, 3, 2) represents a shipping container which is stacked at the storage location (5, 3) and which is second-from-bottom shipping container in the stack. Simply put, a storage location is represented by a two dimensional (2D) matrix value (row and column), whereas a shipping container is represented by a three dimensional (3D) matrix value (row, column, and level)

The users of the computer-implemented system and method may include, for example, a person or entity that owns a rewrote user terminal comprising a computing device, which in turn may comprise wireless computing device; a person or entity that operates or utilizes a remote user terminal comprising a computing device, which in turn may comprise a wireless computing device; or a person or entity that is otherwise associated with a remote user terminal comprising a computing device, which in turn may comprise a wireless computing device.

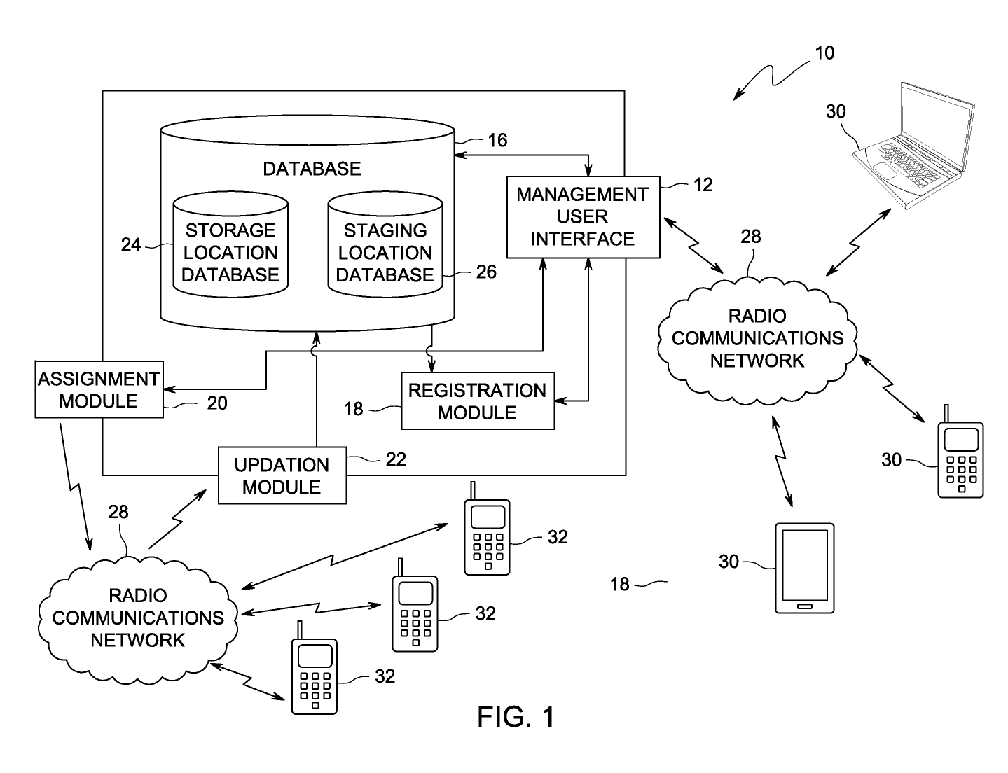

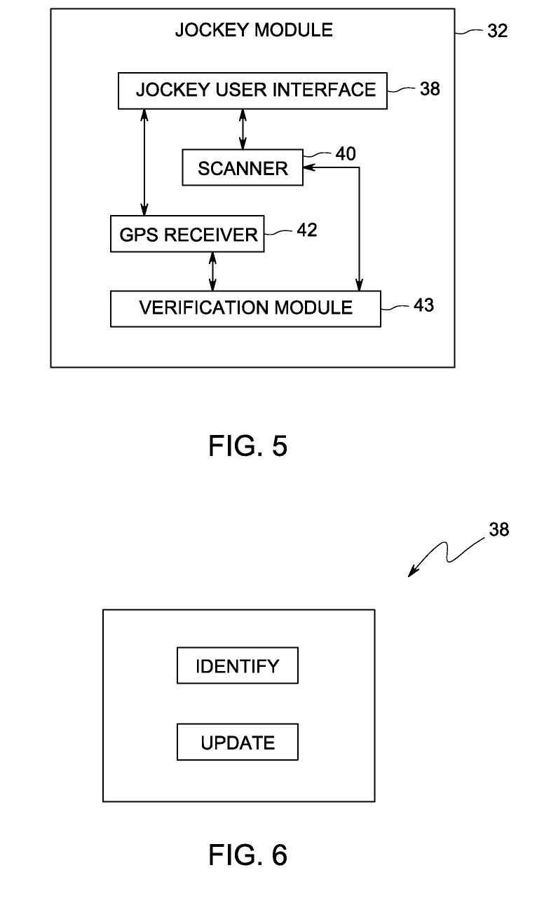

Referring to FIG. 1, the computer-implemented system 10 of the present invention comprises a user interface, a database 16, a registration module 18, an assignment module 20, a plurality of jockey devices 32, and an updation module 22. The user interface is further divided into a plurality of user interfaces comprising a management user interface 12 and a jockey user interface (38 shown in FIG. 5) wherein, the management user interface 12 enables the management cadre personnel of the container terminal to interact with the container terminal management system 10, whereas the jockey user interface enables yard jockeys, who basically are in charge of moving the shipping containers from one place to another within the container terminal, to interact with the container terminal management system 10. Notably, the jockey user interface is adapted to have a limited interface with the container terminal management system 10 as compared to that of the management user interface 12. The management user interface 12, more particularly, comprises a graphical user interface facilitated by remote user terminals 30 comprising commonplace computing devices such as, desktop computers, laptops, a tablet PCs, smartphones, etc., capable of transacting data over a radio communications network 28, such as, the Internet. Handheld wireless user terminals 32, such as, smartphones, tablets, etc., are employed to facilitate the jockey user interface, the reason for which will be apparent from the following body of text.

Referring to FIG. 1, the database 16, which further, for ease of understanding, is divided into a storage location database 24 and a staging location database 26. Referring additionally to Table 1, which represents an exemplary storage location database 24, the storage database 24 comprises a plurality of storage location entries, each of which represents a storage location (represented by a 2D matrix value) where, as mentioned earlier, the shipping containers are stacked. Each storage entry is associated with one or more GPS coordinates that fall within the corresponding storage location area. Each storage entry is further associated with a container number entry, which comprises a number representing the number of shipping containers stacked at the corresponding storage location. More particularly, the number representing a container number entry ranges between zero and n, where ‘n’ represents a predetermined maximum number of shipping containers that can be stacked at a storage location. Each storage entry is further associated one to n container level entries, viz., first container level entry, second container level entry, third container level entry, so on and so forth up to nth container level entry wherein, the first container level entry represents the first-from-bottom shipping container at the corresponding storage location, the second container level entry represents the second-from-bottom shipping container at the corresponding storage location, so on and so forth up to the nth container level entry, which represents the nth-from-bottom or first-from-top shipping container at the corresponding storage location. Notably, if the number of shipping containers stacked at a storage location is below n, then the corresponding container level entries that are not being occupied are associated with zero, nil, or the like. For example, in Table 1, the storage location (2, 1) has only one container number meaning that only one shipping container is at placed at (2, 1). Therefore, the first container level reflects the exemplary identification code (PB269) of the shipping container, while the rest of the container levels are marked with zero.

Referring to FIG. 1, the staging database 26, on the other hand, is relatively simple database comprising a plurality of GPS coordinates that fall within the staging location area, and a plurality of arrival and departure entries categorically listed therewithin wherein, an arrival entry represents a shipping container that has just arrived within container terminal awaiting the storage thereof, and whereas, a departure entry represents a shipping container brought from its storage location into the staging location to await the impending departure thereof. The shipping containers representing both arrival and departure entries are represented by the identification codes thereof.

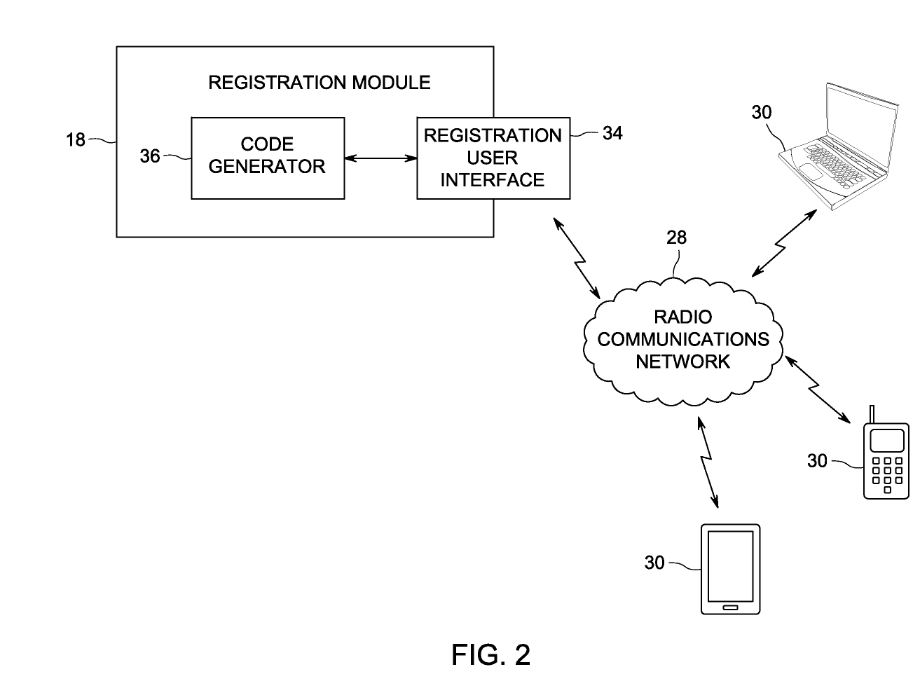

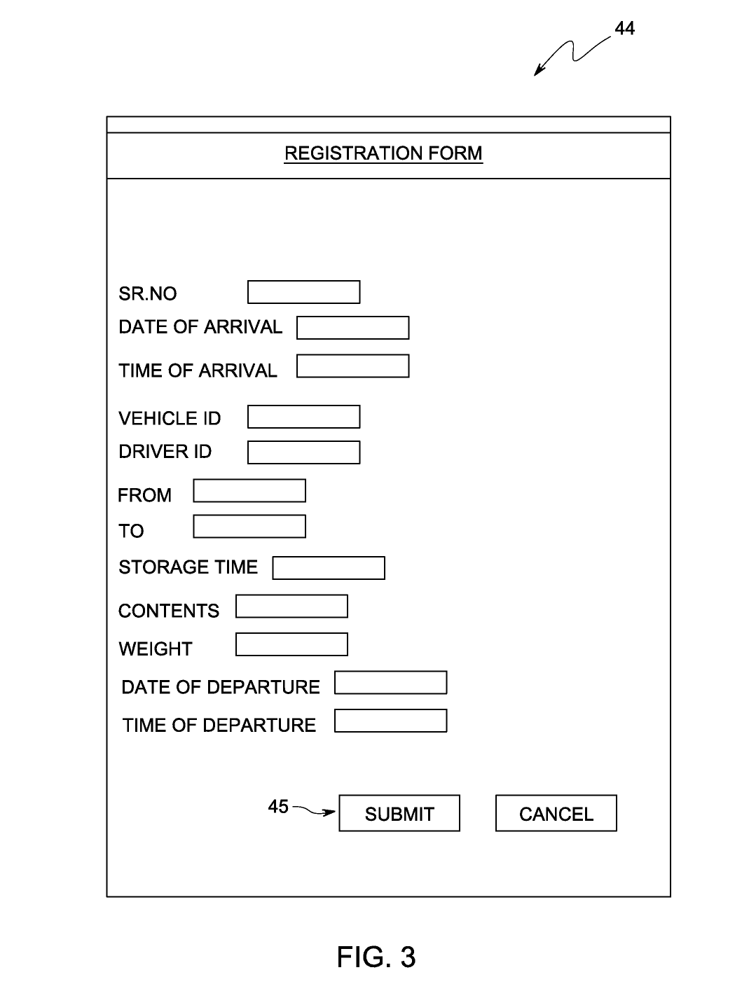

Referring to FIGS. 1 through 3, the registration module 18, as the term suggests, is configured to register incoming shipping containers so as to be eligible for storage at the container terminal. The registration module 18 comprises a registration user interface 34, which is a part of the management user interface 12, and a code generator 36. The registration user interface 34, similar to the management user interface 12, comprises a graphical user interface facilitated by remote user terminals 30 comprising commonplace computing devices such as, desktop computers, laptops, a tablet PCs, smartphones, etc., that are capable of transacting data over a radio communications network 28, such as, the Internet. The registration for an incoming new shipping container is performed by receiving registration details pertaining thereto via a registration form 44 shown in FIG. 3. The registration details include the serial number of the shipping container, the date and time of arrival of the shipping container at the container terminal, the location from which the shipping container has arrived, the intended location to which the shipping container departs, the intended date and time of departure of the shipping container, the intended duration of storage of the shipping container within the container terminal, the identity of the vehicle upon which, the shipping container has arrived at the container terminal, the company or companies undertaking the transportation of the shipping container, and the contents of the shipping container. Except for the serial number and the arrival date and time of the shipping container, rest of the details is manually entered into the registration form. In one embodiment, the various scanning devices may be employed to scan the details of the shipping container or the arrival vehicle thereof in order to receive the details within the registration form. For example, if the shipping container has arrived on a truck, the VIN of the truck may be received by an appropriate scanning device.

Referring to FIGS. 1 through 3, once the details are received by the registration form 44 and submitted by selecting the ‘Submit’ button 45, the registration details are parsed for errors. If errors are found, the user is prompted to re-enter the faulty registration details. If no errors are found, an identification code is generated by the code generator 36 that has all the registration details thereof encoded thereinto. Preferably, the identification code comprises a Quick Response (QR) code, which is known to have greater storage capacity, quicker readability and an ability to be encoded with multiple data types. The generated identification code is printed out and is attached to a durable, weather resistant, tear proof tag, which in turn is attached to the shipping container. In some case, considering the large sizes of the shipping container, multiple tags attached with the same identification code may be attached to the shipping container. The shipping container is then moved to the staging location before being moved to a storage location. Further, the identification code of the shipping container is added to staging database 26 under arrival entries indicating the shipping container represented by the identification code thereof is at the staging location.

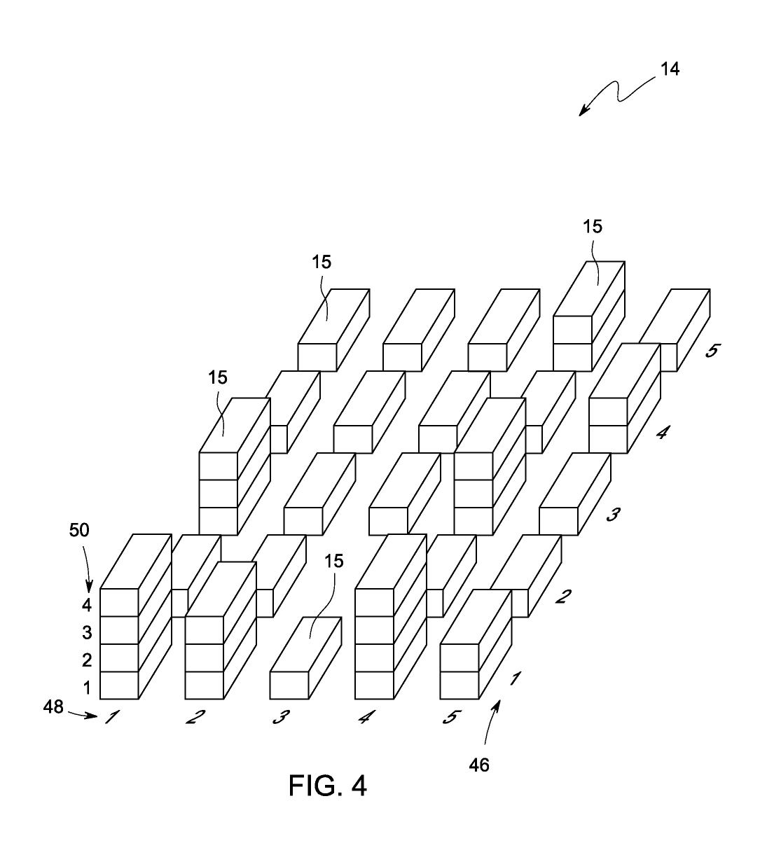

Referring to FIG. 1, the assignment module 20, which is disposed in operative communication with the database 16, enables the container terminal management, via the management user interface 12, to order a shipping container (identified by the identification code thereof) to be moved from the staging location to a storage location (r, c), from a storage location (r, c, l) to the staging location, and from one storage location to another storage location within the container terminal. In one embodiment, for each new shipping container arrived at the staging location, the storage location therefor is automatically assigned by the assignment module 20 wherein, the storage location is chosen in a random manner. In one embodiment, the storage locations that are least occupied are given preference over those that are relatively more occupied. In another embodiment, the assignment module 20 is configured such that, the user is prompted to select a shipping container after which, the storage location therefor is automatically and randomly assigned by the assignment module 20. In yet another embodiment, the user upon selecting a shipping container, accesses an interactive map 14 (FIG. 4) of the container terminal wherefrom a storage location for the shipping container is selected.

Referring to FIGS. 1 and 4, the interactive map 14, which is a part of the assignment module 20 and accessible via the management user interface 12, comprises a 3D map of the container terminal, which is a graphical representation of the entries within the storage database 24. Therefore, the map 14 displays graphical images of the storage locations in the matrix formation and the graphical images of the shipping containers 15 stacked at the storage locations. Further, each storage location within the map is configured to be selectable so as to assign a storage location for a shipping container at the staging location or at another storage location by the selection thereof. In one embodiment, when a cursor is hovered over a storage location, the storage location is configured to be highlighted displaying the identity of thereof ((r, c) value) and prompting the user to ‘assign’ the storage location, provided a shipping container is earlier selected to be moved thereto. Each shipping container 15 in the map 14 is also configured to be selectable so as to order a selected shipping container 15 to be moved to the staging location or to another storage location. In one embodiment, when a cursor is hovered over a shipping container 15, the shipping container 15 is configured to be highlighted displaying the details thereof (identification code, serial number, and/or (r, c, l) value) and prompting the user to either ‘move’ the shipping container 15 to the ‘staging location’ or to another ‘storage location’, which may also be selected from the map 14 itself as in the earlier mentioned manner. The map 14 is configured to be panned, zoomed in and out, and rotated.

Referring to FIGS. 1, 5 and 6, once a shipping container, as enabled by the assignment module 20, is ordered to be moved from one location to another, the assignment, via a the communications network 28, is delivered to a jockey device 32 pertaining to a yard jockey, who, as mentioned earlier, is in charge of moving the shipping containers from one location to another within the container terminal. A jockey device 32 comprises a handheld computing device comprising a verification module 43 and is necessarily equipped with a scanner 40 and a GPS receiver 42, the utility of each of which will be apparent from the following body of text. Preferably, the jockey device 32 comprises a smartphone equipped with a camera that acts as a scanner and a GPS receiver. Once the assignment is delivered, at this point, in one embodiment, the yard jockey is prompted to accept or reject the assignment. Upon rejection, the assignment is allotted to another yard jockey by delivering the same assignment to his/her jockey device 32. However, upon acceptance, the yard jockey is provided with the details of the assignment on his/her jockey device 32, such as, the current location of the shipping container (the staging location or (r, c, l) value), the destination location of the shipping container (the staging location or (r, c) value), the identification code of the shipping container, the GPS coordinates of the destination location, etc. Further an assignment screen 38 is obtained by the jockey device 32 which comprises an exemplary “identify” button and an exemplary “update” button, the utility of each of which will be apparent from the following body of text.

Referring to FIGS. 5 and 6, based on the details of the assignment, once the yard jockey reaches the current location of the shipping container, the yard jockey may ascertain a right shipping container among a plurality thereof by selecting the “identity” button, which then activates the camera 40 for scanning the identification code of a shipping container or containers. In one embodiment, if the current location of the shipping container comprises a storage location, then the arrival of the yard jockey thereto is guided by the GPS system on his/her jockey device. Upon the yard jockey finding the right shipping container, transporting the same to the destination location, and laying it down, selecting the “update” button updates the database accordingly. In one embodiment, if the destination location of the shipping container comprises a storage location, then, as seen in the earlier scenario, the arrival of the yard jockey thereto is guided by the GPS system on his/her jockey device 32.

Referring to FIGS. 1, 5 and 6, if an incoming shipping container is brought to a storage location from the staging location, updating the database 16 by selecting the “update” button would result in both the storage and staging databases 24 and 26 being updated accordingly. More particularly, upon the yard jockey's selection of the “update” button at the storage location, a verification is performed by activating the camera 40 thereof for scanning the identification code. Upon mismatch, an appropriate mismatch message is displayed indicating the yard jockey to take the shipping container back to the original location thereof and repeat the process. However, upon match, the GPS coordinates of the jockey device 32 are received from the GPS receiver 42 on the jockey device 32. If there is a mismatch between the GPS coordinates pertaining to the storage location assigned to the incoming shipping container and the GPS coordinates received by the jockey device 32 implying that the incoming shipping container is moved to a wrong storage location, a mismatch message is displayed indicating the yard jockey to move the incoming shipping container to the correct destination. However, upon match, the identification code of the incoming shipping container is disassociated with arrival entries in the staging database 26 and is associated with the top container level entry that corresponds to the appropriate storage location entry and simultaneously increasing the container number entry by one count. For example, if a incoming shipping container is added to the container stack at the storage location comprising two shipping containers, then the identification code of the incoming shipping container is added to the third container level entry of the corresponding storage location entry and simultaneously the corresponding container number entry count is increased from two to three indicating an addition.

Referring to FIGS. 1, 5 and 6, on the other hand, if an outgoing shipping container is brought to a staging location from a storage location, updating the database 16 by selecting the “update” button would result in again both the storage and staging databases 24 and 26 being updated accordingly. More particularly, upon the yard jockey selecting the “update” button at the staging location, a verification is performed by activating the camera 40 thereof for scanning the identification code. Upon mismatch, an appropriate mismatch message is displayed indicating the yard jockey to take the container back to the original location thereof and repeat the process.

However, upon match, the GPS coordinates of the jockey device are received from the GPS receiver 42 on the jockey device 32. If there is a mismatch between the GPS coordinates of the staging location and the GPS coordinates received by the jockey device 32 implying that the outgoing shipping container is at a location, a mismatch message is displayed indicating the yard jockey to move the outgoing shipping container to the correct destination. However, upon match, the identification code of the outgoing shipping container is disassociated from the appropriate container level entry corresponding to the storage location from where the outgoing shipping container is moved, the resultant downward shift of the shipping containers stacked above the outgoing container is automatically reflected in the storage database 24, the corresponding container number entry is decreased by one count and the identification code of the outgoing shipping container is associated with the departure entries in the staging database 26. For example, if a second level outgoing shipping container is moved from a stack of five to the staging location, the identification code of the outgoing shipping container is disassociated with the second container level entry pertaining to the corresponding storage location, the third, fourth and fifth shipping container level entries are moved to second, third, and fourth container level entries respectively, the container number entry is decreased by one count indicating a removal, and the identification code of the outgoing shipping container is associated with the departure entries in the staging database 26.

Referring to FIGS. 1, 5 and 6, if a relocating shipping container is relocated within the container terminal from a previous storage location to a new storage location, updating the database 16 by selecting the “update” button would result in the storage database 24 being updated accordingly. More particularly, upon the yard jockey selecting the “update” button at a storage location, a verification is performed by activating the camera 40 thereof for scanning the identification code. Upon mismatch, an appropriate mismatch message is displayed indicating the yard jockey to take the container back to the original location thereof and repeat the process. However, upon match, the GPS coordinates of the jockey device are received from the GPS receiver on the jockey device. If there is a mismatch between the GPS coordinates of the storage location and the GPS coordinates received by the jockey device implying that the relocating shipping container is at a wrong location, a mismatch message is displayed indicating the yard jockey to move the relocating shipping container to the correct destination. However, upon match, the identification code of the relocating shipping container is disassociated from the appropriate container level entry corresponding to the previous storage location from where the relocating shipping container is moved, the resultant downward shift of the shipping containers stacked above the relocating container is automatically reflected in the storage database, the corresponding container number entry is decreased by one count, the top container level entry that corresponds to the new storage location is associated with the identification code of the relocating shipping container, and the container number entry by one count pertaining to the new storage location is increase by one count indicating an addition. For example, if a second level relocating shipping container is moved from a stack of five at a previous storage container to a new container stack of two at a new storage location, the identification code of the relocating shipping container is disassociated with the second container level entry pertaining to the previous storage location, the third, fourth and fifth shipping container level entries are moved to second, third, and fourth container level entries respectively, the container number entry is decreased by one count indicating a removal, the identification code of the relocating shipping container is added to the third container level entry of the new storage location entry and the container number entry corresponding to the new storage location is increased from by one count to three indicating an addition.

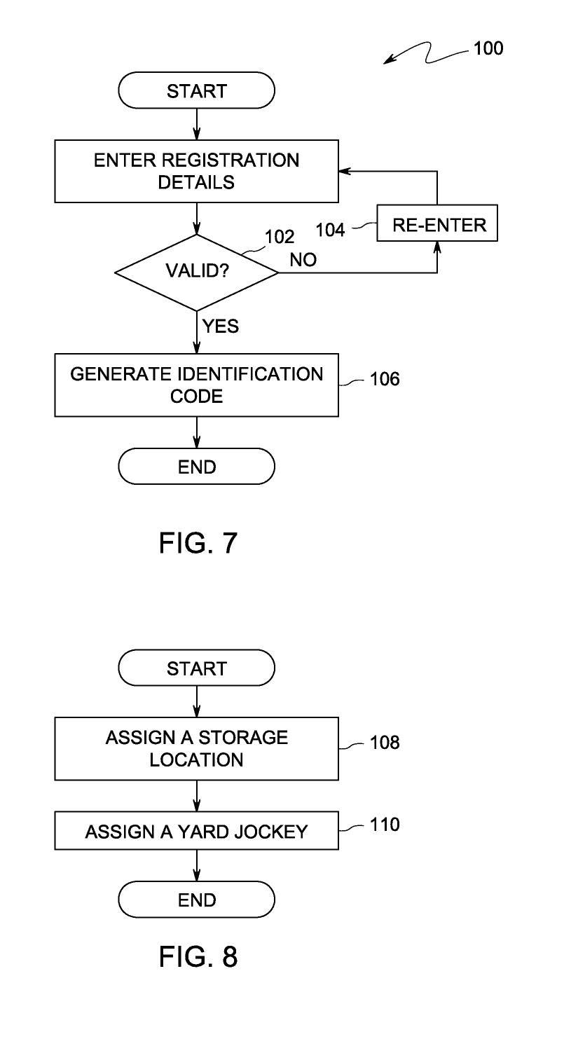

Referring to FIG. 7, the computer-implemented container terminal management method of the present invention initiates with the registration of shipping containers that arrive within a container terminal for storage. The method of registration initiates with receiving registration details (step 100) via a registration form wherein, the registration details include the serial number of the shipping container, the date and time of arrival of the shipping container at the container terminal, the location from which the shipping container has arrived, the intended location to which the shipping container departs, the intended date and time of departure of the shipping container, the intended duration of storage of the shipping container within the container terminal, the identity of the vehicle upon which, the shipping container has arrived at the container terminal, the company or companies undertaking the transportation of the shipping container, and the contents of the shipping container. Except for the serial number and the arrival date and time of the shipping container, rest of the details is manually entered into the registration form. In one embodiment, the various scanning devices may be employed to scan the details of the shipping container or the arrival vehicle thereof in order to receive the details within the registration form. For example, if the shipping container has arrived on a truck, the VIN of the truck may be received by an appropriate scanning device.

Referring to FIG. 7, once the registration details are received and submitted, the container details are parsed for errors (step 102). If errors are found, the user is prompted to re-enter (step 104) the faulty registration details. If no errors are found, an identification code is generated (step 106) by a code generator that has all the registration details thereof encoded thereinto. Preferably, the identification code comprises a Quick Response (QR) code, which is known to have greater storage capacity, quicker readability and an ability to be encoded with multiple data types. The generated identification code is printed out and is attached to a durable, weather resistant, tear proof tag, which in turn is attached to the shipping container. In some case, considering the large sizes of the shipping container, multiple tags attached with the same identification code may be attached to the shipping container. The shipping container is then moved to the staging location before being moved to a storage location. Further, the identification code of the shipping container is added to a database indicating the shipping container represented by the identification code thereof is at the staging location.

The shipping containers within the container terminal and the current locations thereof are recorded in a database, which, for ease of understanding is divided into a staging location database, where newly registered shipping containers and shipping containers awaiting departure from the container terminal are listed, and a storage location database, where shipping containers at the storage locations are listed. More particularly, the staging database comprises a plurality of GPS coordinates that fall within the staging location area, and a plurality of arrival and departure entries categorically listed therewithin wherein, an arrival entry represents a shipping container that has just arrived within container terminal awaiting the storage thereof, and whereas, a departure entry represents a shipping container brought from its storage location into the staging location to await the impending departure thereof.

The storage database, on the other hand, comprises a plurality of storage location entries, each of which representing a storage location where, as mentioned earlier, the shipping containers are stacked. Each storage entry is associated with one or more GPS coordinates that fall within the corresponding storage location area. Each storage entry is further associated with a container number entry, which comprises a number representing the number of shipping containers stacked at the corresponding storage location. More particularly, the number representing a container number entry ranges between zero and n, where ‘n’ represents a predetermined maximum number of shipping containers that can be stacked at a storage location. Each storage entry is further associated one to n container level entries, viz., first container level entry, second container level entry, third container level entry, so on and so forth up to nth container level entry wherein, the first container level entry represents the first-from-bottom shipping container at the corresponding storage location, the second container level entry represents the second-from-bottom shipping container at the corresponding storage location, so on and so forth up to the nth container level entry, which represents the nth-from-bottom or first-from-top shipping container at the corresponding storage location. Notably, if the number of shipping containers stacked at a storage location is below n, then the corresponding container level entries that are not being occupied are associated with zero, nil, or the like.

The primary operations within the container terminal includes an incoming operation comprising moving a shipping container from a staging location to a storage location, an outgoing operation comprising moving a shipping container from a storage location to a staging location, and finally, a relocation operation comprising moving a shipping container from one storage location to another storage location. Hereinafter, for convenience, the shipping container that is being moved from a staging location to a storage location will be referred to as an incoming shipping container, the shipping container that is being moved from a storage location to a staging location will be referred to as an outgoing shipping container, and finally, the shipping container that is being moved from one storage location to another will be referred to as a relocating shipping container.

Referring to FIG. 8, the method of initiating an operation initiates with selecting a shipping container (step 108) for an incoming, outgoing, or a relocation operation. For the incoming operation, the shipping container is selected from the staging location, for the outgoing operation, the shipping container is selected from a storage location, and for a relocation operation, the shipping container is selected from a storage location. Especially, for the outgoing and relocation operations, the shipping container is selected from an interactive 3D map of the container terminal, which is a graphical representation of the entries within the storage database. Therefore, the map displays graphical images of the storage locations in the matrix formation and the graphical images of the shipping containers stacked at the storage locations. Each shipping container in the map is configured to be selectable so as to order a selected shipping container to be moved to the staging location or to another storage location. In one embodiment, when a cursor is hovered over a shipping container, the shipping container is configured to be highlighted displaying the details thereof (identification code, serial number, and/or (r, c, l) value) and prompting the user to either ‘move’ the shipping container to the ‘staging location’ or to another ‘storage location’, which may also be selected from the map itself as in the earlier mentioned manner.

Referring to FIG. 8, once the shipping container is selected, the destination location is assigned thereto (step 109), which could be the staging location or a storage location. A storage location may be assigned again with the help of the map as the storage locations therewithin are configured to be selectable so as to assign the same. In one embodiment, when a cursor is hovered over a storage location, the storage location is configured to be highlighted displaying the identity of thereof ((r, c) value) and prompting the user to ‘assign’ the storage location, provided a shipping container is earlier selected to be moved thereto. The map is configured to be panned, zoomed in and out, and rotated. Once the shipping container and the destination thereof is determined, the operation assignment is allotted to a yard jockey (step 110), who is in charge of the operations at a container terminal, by delivering the operation assignment on his/her jockey device, which preferably comprises a smartphone equipped with a camera that acts as a scanner and a GPS receiver, the utility of each of which will be apparent from the following body of text. Along with the operation assignment the operation details such as, the current location of the shipping container (the staging location or (r, c, l) value), the destination location of the shipping container (the staging location or (r, c) value), the identification code of the shipping container, the GPS coordinates of the destination location, etc., are provided to the yard jockey. Further an assignment screen is obtained by the jockey device which comprises an exemplary “update” button, the utility of which will be apparent from the following body of text.

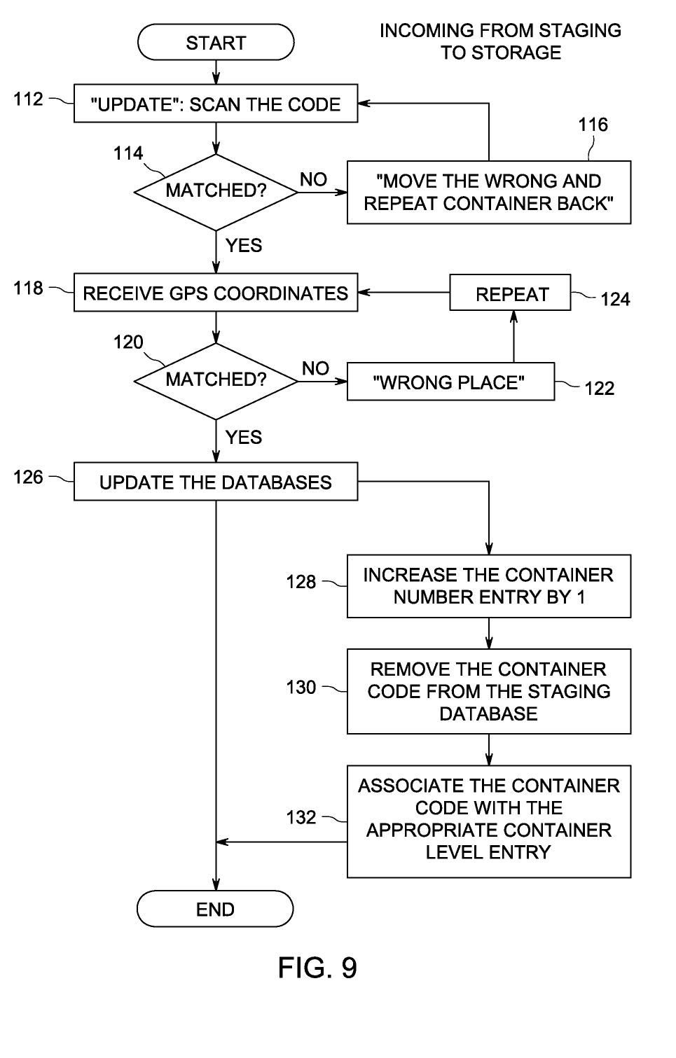

Referring to FIG. 9, if the operation comprises an incoming operation, upon the yard jockey delivering the incoming shipping container to the destination thereof, selecting the “update” button initially scans (step 112) the identification code of the incoming shipping container. A verification (step 114) is performed between the identification code that is scanned and the actual identification code that is earlier delivered to the jockey device. Upon mismatch, an appropriate mismatch message is displayed (step 116) indicating the yard jockey to take the shipping container back to the original location thereof and repeat the process. However, upon match, the GPS coordinates of the jockey device are received (step 118) from the GPS receiver on the jockey device. Once again, a verification (step 120) is performed between the GPS coordinates that are received and the actual GPS coordinates that are earlier delivered to the jockey device. If there is a mismatch between the GPS coordinates pertaining to the storage location assigned to the incoming shipping container and the GPS coordinates received by the jockey device implying that the incoming shipping container is moved to a wrong storage location, a mismatch message is displayed (step 122) indicating the yard jockey to move the incoming shipping container to the correct destination (step 124). However, upon match, the database is updated (step 126) accordingly. More particularly, the database updation entails the identification code of the incoming shipping container being disassociated from arrival entries in the staging database (step 130) and is associated with the top container level entry (step 132) that corresponds to the appropriate storage location entry and simultaneously increasing the container number entry by one count (step 128). For example, if a incoming shipping container is added to the container stack at the storage location comprising two shipping containers, then the identification code of the incoming shipping container is added to the third container level entry of the corresponding storage location entry and simultaneously the corresponding container number entry count is increased from two to three indicating an addition.

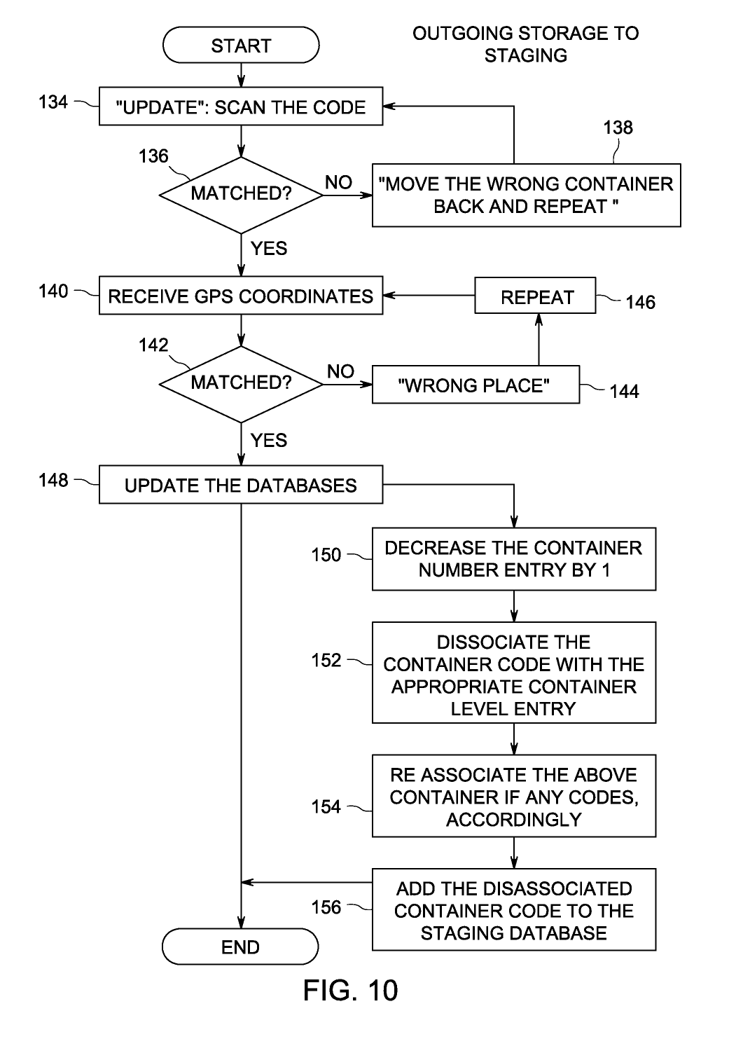

Referring to FIG. 10, if the operation comprises an outgoing operation, upon the yard jockey delivering the outgoing shipping container to the destination thereof, selecting the “update” button initially scans (step 134) the identification code of the outgoing shipping container at the destination location. A verification (step 136) is performed between the identification code that is scanned and the actual identification code that is earlier delivered to the jockey device. Upon mismatch, an appropriate mismatch message is displayed (step 138) indicating the yard jockey to take the container back to the original location thereof and repeat the process. However, upon match, the GPS coordinates of the jockey device are received (step 140) from the GPS receiver on the jockey device. Once again, a verification (step 142) is performed between the GPS coordinates that are received and the actual GPS coordinates that are earlier delivered to the jockey device. If there is a mismatch between the GPS coordinates of the staging location and the GPS coordinates received by the jockey device implying that the outgoing shipping container is at a location, a mismatch message (step 144) is displayed indicating the yard jockey to move the outgoing shipping container to the correct destination (step 146). However, upon match, the database is updated (step 148) accordingly. More particularly, the database updation entails the identification code of the outgoing shipping container being disassociated (step 152) from the appropriate container level entry corresponding to the storage location from where the outgoing shipping container is moved, the resultant downward shift of the shipping containers stacked above the outgoing container being automatically reflected (step 154) in the storage database, the corresponding container number entry being decreased by one count (step 150) and the identification code of the outgoing shipping container being associated with the departure entries (step 156) in the staging database. For example, if a second level outgoing shipping container is moved from a stack of five to the staging location, the identification code of the outgoing shipping container is disassociated with the second container level entry pertaining to the corresponding storage location, the third, fourth and fifth shipping container level entries are moved to second, third, and fourth container level entries respectively, the container number entry is decreased by one count indicating a removal, and the identification code of the outgoing shipping container is associated with the departure entries in the staging database.

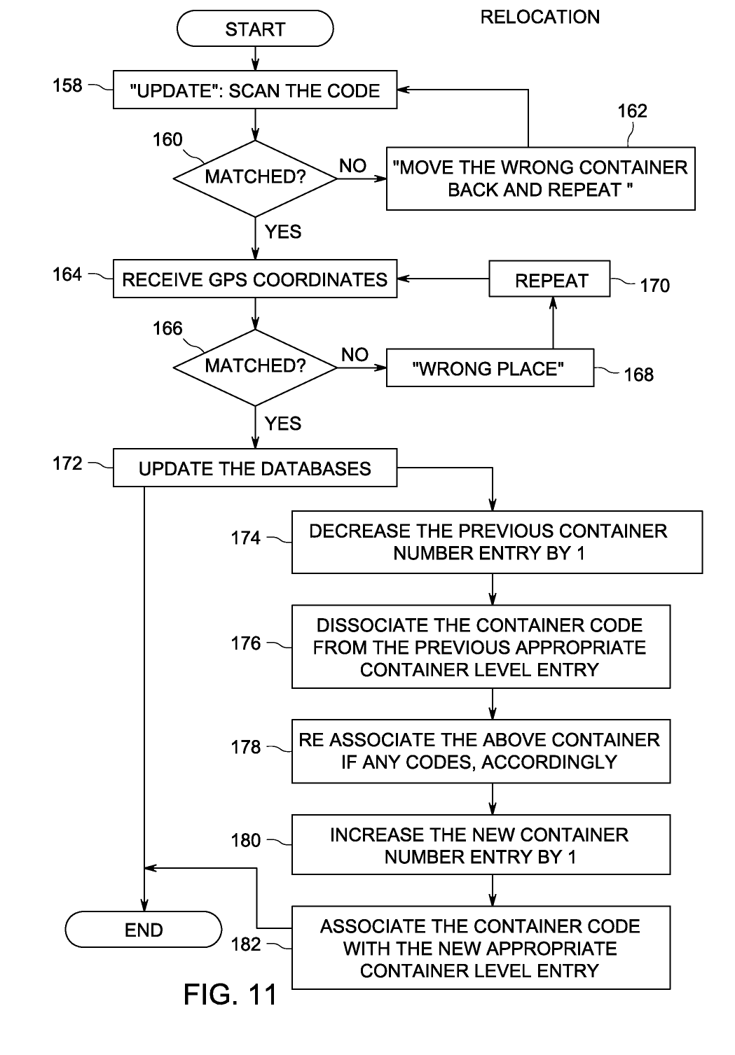

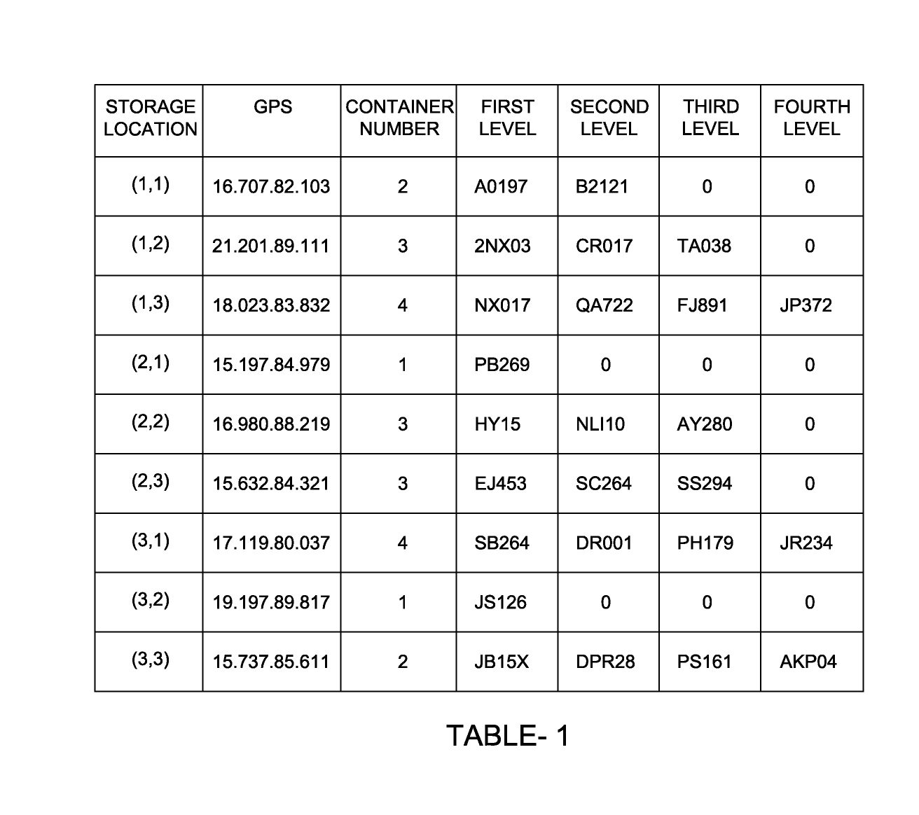

Referring to FIG. 11, if the operation comprises a relocation operation, upon the yard jockey delivering the relocation shipping container to the destination thereof, selecting the “update” button initially scans (step 158) the identification code of the relocation shipping container at the destination location. A verification (step 160) is performed between the identification code that is scanned and the actual identification code that is earlier delivered to the jockey device. Upon mismatch, an appropriate mismatch message is displayed (step 162) indicating the yard jockey to take the container back to the original location thereof and repeat the process. However, upon match, the GPS coordinates of the jockey device are received (step 164) from the GPS receiver on the jockey device. Once again, a verification (step 166) is performed between the GPS coordinates that are received and the actual GPS coordinates that are earlier delivered to the jockey device. If there is a mismatch between the GPS coordinates of the storage location and the GPS coordinates received by the jockey device implying that the relocating shipping container is at a wrong location, a mismatch message is displayed (step 168) indicating the yard jockey to move the relocating shipping container to the correct destination (step 170). However, upon match, the database is updated (step 172) accordingly. More particularly, the database updation entails the identification code of the relocating shipping container being disassociated (step 176) from the appropriate container level entry corresponding to the previous storage location from where the relocating shipping container is moved, the resultant downward shift of the shipping containers stacked above the relocating container being automatically reflected in the storage database (step 178), the corresponding container number entry being decreased by one count (step 174), the top container level entry that corresponds to the new storage location being associated with the identification code of the relocating shipping container (step 180), and the container number entry pertaining to the new storage location being increased by one count indicating an addition (step 182). For example, if a second level relocating shipping container is moved from a stack of five at a previous storage container to a new container stack of two at a new storage location, the identification code of the relocating shipping container is disassociated with the second container level entry pertaining to the previous storage location, the third, fourth and fifth shipping container level entries are moved to second, third, and fourth container level entries respectively, the container number entry is decreased by one count indicating a removal, the identification code of the relocating shipping container is added to the third container level entry of the new storage location entry and the container number entry corresponding to the new storage location is increased from by one count to three indicating an addition.

Discussions herein utilizing terms such as, for example, “processing,” “computing,” “calculating,” “determining,” “establishing,” “analyzing,” “checking,” or the like, is able to refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that is able to store instructions to perform operations and/or processes.

The aforementioned embodiments are able to take the form of an entirely hardware embodiment, an entirely software embodiment, or an embodiment including both hardware and software elements. The embodiments are able to be implemented in software, which includes but is not limited to firmware, resident software, microcode, or the like.

The aforementioned embodiments are able to be implemented, for example, using a machine-readable medium or article which is able to store an instruction or a set of instructions that, if executed by a machine, cause the machine to perform a method and/or operations described herein. Such machine is able to include, for example, any suitable processing platform, computing platform, computing device, processing device, electronic device, electronic system, computing system, processing system, computer, processor, or the like, and is able to be implemented using any suitable combination of hardware and/or software. The machine-readable medium or article is able to include, for example, any suitable type of memory unit, memory device, memory article, memory medium, storage device, storage article, storage medium and/or storage unit; for example, memory, removable or non-removable media, erasable or non-erasable media, writeable or re-writeable media, digital or analog media, hard disk drive, floppy disk, Compact Disk Read Only Memory (CD-ROM), Compact Disk Recordable (CD-R), Compact Disk Re-Writeable (CD-RW), optical disk, magnetic media, various types of Digital Versatile Disks (DVDs), a tape, a cassette, or the like. The instructions is able to include any suitable type of code, for example, source code, compiled code, interpreted code, executable code, static code, dynamic code, or the like, and is able to be implemented using any suitable high-level, low-level, object-oriented, visual, compiled and/or interpreted programming language, e.g., C, C++, Java, BASIC, Pascal, Fortran, Cobol, assembly language, machine code, or the like. Functions, operations, components and/or features described herein with reference to one or more embodiments, is able to be combined with, or is able to be utilized in combination with, one or more other functions, operations, components and/or features described herein with reference to one or more other embodiments, or vice versa.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the invention with modifications. However, all such modifications are deemed to be within the scope of the claims.

What is claimed is:

1. A computer-implemented system for managing a container terminal, comprising:
(a) a user interface;
(b) a registration module for generating a unique, machine-readable, identification code for each shipping container that arrives at the container terminal for storage therewithin, a code comprising the details of the corresponding shipping container that are received via the user interface, each code imprinted on an identification tag that is adapted to be affixed to the corresponding shipping container thereof thereby registering the corresponding shipping container therewith, a registered shipping container initially moved to a staging location defined by a plurality of GPS coordinates that fall within the area thereof;
(c) a storage location database disposed in operative communication with the user interface and the registration module, the storage location database comprising a plurality of storage location entries, each of which representing a shipping container storage location within the container terminal, each storage location entry associated with one or more GPS coordinates that fall within the corresponding storage location area, and a container number entry, which represents the number of shipping containers stacked at the corresponding storage location, the number of shipping containers ranging from zero to n where, ‘n’ represents a predetermined maximum number of containers that can be stacked at a storage location, the storage locations associated container number entries comprising zero referred to as vacant storage locations, the storage locations associated container number entries comprising one to n referred to as occupied storage locations, each storage location entry further associated with one to n container level entries, viz., first container level entry, second container level entry, so on and so forth, up to nth container level entry wherein, the first container level entry represents the identification code pertaining to the first-from-bottom shipping container at the corresponding storage location, the second container level entry represents the identification code pertaining to the second-from-bottom shipping container at the corresponding storage location, so on and so forth up to the nth container level entry representing the identification code pertaining to the nth-from-bottom or the first-from-top shipping container at the corresponding storage location, a container level entry not being occupied by a shipping container represented accordingly by zero, nil, etc.;
(d) an assignment module for, via the user interface, ordering a shipping container to be moved from the staging location to a storage location, from the current storage location thereof to the staging location, or from the current storage location thereof to a new storage location, the shipping container represented by the identification code thereof;
(e) a handheld verification device disposed in operative communication with the storage location database, the verification device for verifying whether or not a shipping container is moved to an ordered storage location or staging location, the verification device comprising:
(i) a scanner for scanning the identification code on a shipping container moved to a storage location assigned thereto or the staging location, the code scanned at the storage or staging location; and
(ii) a GPS Receiver for receiving the GPS coordinates thereof during the scanning; and
(f) an updation module for, upon successful verification, i.e., upon the match between the GPS coordinates received by the GPS Receiver and the GPS coordinates of the storage or staging locations, updating the appropriate container number entries and the container level entries within the storage location database accordingly.

2. The system of claim 1 wherein, the updation of a container number entry upon successful verification of a shipping container moved to a storage location comprises increasing by number represented by current container number entry by one.

3. The system of claim 1 wherein, the updation of a container number entry upon successful verification of a shipping container removed from a storage location comprises decreasing by number represented by current container number entry by one.

4. The system of claim 1 wherein, the updation of a container level entry upon successful verification of a shipping container moved to a storage location comprises associating the identification code of the shipping container to a container level entry that corresponds to the number represented by the corresponding container number entry that pertains to the corresponding storage location entry.

5. The system of claim 1 wherein, the updation of a container level entry upon successful verification of a shipping container removed from a storage location comprises disassociating the identification code of the shipping container from the appropriate container level entry pertaining to the corresponding storage location entry and re-associating the identification code or codes of the shipping containers that are stacked above the removed shipping container accordingly.

6. The system of claim 1 wherein, the tag made of a durable, weather and tear resistant material.

7. The system of claim 1 wherein, the code comprises QR code.

8. The system of claim 1 wherein, the code comprises barcode.

9. The system of claim 1 wherein, the container details comprise the arrival date and time of the shipping container within the container terminal, the location from which the shipping container has arrived, the location to which the shipping container departs, the intended departure date and time of the shipping container, the amount of time for which the shipping container is intended to be stored within the container terminal, the transportation vehicle by which the shipping container has arrived, the identity of the transportation vehicle, the size of the shipping container, the contents of the shipping container, and the company undertaking the transportation of the shipping container.

10. The system of claim 1 wherein, the storage locations are formed in a matrix formation whereby, each storage location is identified by a row and column value; each storage location entry within the location database associated with the corresponding row and column value.

11. The system of claim 1 wherein, the assignment module comprises an interactive map of the container terminal accessible via the user interface, the interactive map including the graphical representation of:
(a) the formation of the storage locations across the container terminal, the storage locations selectable for assigning a storage location to a shipping container; and
(b) at the respective storage locations, the shipping containers that are selectable for ordering a shipping container to be moved from the current storage location thereof to the staging location and ordering a shipping container to be moved from the current storage location thereof to a new storage location.

12. The system of claim 1 wherein, the verification device comprises a computing device such as a smartphone, phablet, tablet PC, etc.

13. The system of claim 1 further comprising a staging location database disposed in operative communication with the registration module and the storage location database, the staging database comprising a plurality of interim entries wherein, each interim entry represents a shipping container currently within a staging location of the container terminal slated for departure therefrom; the shipping container represented by the identification code thereof, the staging location database, as enabled by the updation module, updated accordingly upon successful verification of the arrival of a shipping container from the container terminal.

14. The system of claim 1 wherein, the scanner comprises a camera.

15. A computer-implemented system for managing a container terminal, comprising:
(a) a user interface;
(b) a registration module for generating a unique, machine-readable, identification code for each shipping container that arrives at the container terminal for storage therewithin, a code comprising the details of the corresponding shipping container that are received via the user interface, each code imprinted on an identification tag that is adapted to be affixed to the corresponding shipping container thereof thereby registering the corresponding shipping container therewith, a registered shipping container initially moved to a staging location;
(c) a storage location database disposed in operative communication with the user interface and the registration module, the storage location database comprising a plurality of storage location entries, each of which representing a shipping container storage location within the container terminal, each storage location entry associated with one or more GPS coordinates that fall within the corresponding storage location area, and a container number entry, which represents the number of shipping containers stacked at the corresponding storage location, the number of shipping containers ranging from zero to n where, ‘n’ represents a predetermined maximum number of containers that can be stacked at a storage location, the storage locations associated container number entries comprising zero referred to as vacant storage locations, the storage locations associated container number entries comprising one to n referred to as occupied storage locations, each storage location entry further associated with one to n container level entries, viz., first container level entry, second container level entry, so on and so forth up to nth container level entry wherein, the first container level entry represents the identification code pertaining to the first-from-bottom shipping container at the corresponding storage location, the second container level entry represents the identification code pertaining to the second-from-bottom shipping container at the corresponding storage location, so on and so forth up to the nth container level entry representing the identification code pertaining to the nth-from-bottom or the first-from-top shipping container at the corresponding storage location, a container level entry not being occupied by a shipping container represented accordingly by zero, nil, etc.;
(d) a staging location database disposed in operative communication with the registration module and the storage location database, the staging database comprising a plurality of GPS coordinates that fall within the area thereof, a plurality of interim entries wherein, each interim entry represents a shipping container currently within a staging location slated for departure therefrom; the shipping container represented by the identification code thereof;
(e) an assignment module for, via the user interface, ordering a shipping container to be moved from the staging location to a storage location, from the current storage location thereof to the staging location, or from the current storage location thereof to a new storage location, the shipping container represented by the identification code thereof;
(f) a handheld verification device disposed in operative communication with the storage location database, the verification device for verifying whether or not a shipping container is moved to an ordered storage location or staging location, the verification device comprising:
(i) a scanner for scanning the identification code on a shipping container moved to a storage location assigned thereto or the staging location, the code scanned at the storage or staging location; and
(ii) a GPS Receiver for receiving the GPS coordinates thereof during the scanning; and
(g) an updation module for, upon successful verification, i.e., upon the match between the GPS coordinates received by the GPS Receiver and the GPS coordinates of the storage or staging locations, updating the appropriate container number entries and the container level entries within the storage location database and the interim entries within the staging location database accordingly.

16. A computer-implemented method for managing a container terminal, comprising:
(a) generating a unique, machine-readable, identification code for each shipping container that arrives at the container terminal, the identification code comprising the details of the corresponding shipping container that are received via a user interface, each identification code imprinted on an identification tag that is adapted to be affixed to the corresponding shipping container thereof thereby registering the corresponding shipping container therewith, a registered shipping container initially moved to a staging location defined by a plurality of GPS coordinates that fall within the area thereof;
(b) listing a plurality of storage location entries within a storage location database wherein, a storage location entry represents a shipping container storage location within the container terminal, each storage location entry associated with one or more GPS coordinates that fall within the corresponding storage location area, and a container number entry, which represents the number of shipping containers stacked at the corresponding storage location, the number of shipping containers ranging from zero to n where, ‘n’ represents a predetermined maximum number of containers that can be stacked at a storage location, the storage locations associated container number entries comprising zero referred to as vacant storage locations, the storage locations associated container number entries comprising one to n referred to as occupied storage locations, each storage location entry further associated with one to n container level entries, viz., first container level entry, second container level entry, so on and so forth up to nth container level entry wherein, the first container level entry represents the identification code pertaining to the first-from-bottom shipping container at the corresponding storage location, the second container level entry represents the identification code pertaining to the second-from-bottom shipping container at the corresponding storage location, so on and so forth up to the nth container level entry representing the identification code pertaining to the nth-from-bottom or the first-from-top shipping container at the corresponding storage location, a container level entry not being occupied by a shipping container represented accordingly by zero, nil, etc.;
(c) ordering, via the user interface, a shipping container to be moved from the staging location to a storage location, from the current storage location thereof to the staging location, or from the current storage location thereof to a new storage location, the shipping container represented by the identification code thereof;
(d) scanning, via a handheld verification device, the identification code on a shipping container moved to a storage location assigned thereto or the staging location, the code scanned at the storage or staging location;
(e) receiving the GPS coordinates of the handheld verification device during the scanning; and
(f) upon on the match between the GPS coordinates received by the GPS Receiver and the GPS coordinates of the storage or staging locations, i.e., upon successful verification, updating the appropriate container number entries and the container level entries within the storage location database accordingly.

17. The method of claim 1 wherein, the updation of a container number entry upon successful verification of a shipping container moved to a storage location comprises increasing by number represented by current container number entry by one.

18. The method of claim 1 wherein, the updation of a container number entry upon successful verification of a shipping container removed from a storage location comprises decreasing by number represented by current container number entry by one.

19. The method of claim 1 wherein, the updation of a container level entry upon successful verification of a shipping container moved to a storage location comprises associating the identification code of the shipping container to a container level entry that corresponds to the number represented by the corresponding container number entry that pertains to the corresponding storage location entry.

20. The method of claim 1 wherein, the updation of a container level entry upon successful verification of a shipping container removed from a storage location comprises disassociating the identification code of the shipping container from the appropriate container level entry pertaining to the corresponding storage location entry and re-associating the identification code or codes of the shipping containers that are stacked above the removed shipping container accordingly.

21. The method of claim 1 wherein, the tag made of a durable, weather and tear resistant material.

22. The method of claim 1 wherein, the code comprises QR code.

23. The method of claim 1 wherein, the code comprises barcode.

24. The method of claim 1 wherein, the container details comprise the arrival date and time of the shipping container within the container terminal, the location from which the shipping container has arrived, the location to which the shipping container departs, the intended departure date and time of the shipping container, the amount of time for which the shipping container is intended to be stored within the container terminal, the transportation vehicle by which the shipping container has arrived, the identity of the transportation vehicle, the size of the shipping container, the contents of the shipping container, and the company undertaking the transportation of the shipping container.

25. The method of claim 1 wherein, the storage locations are formed in a matrix formation whereby, each storage location is identified by a row and column value; each storage location entry within the location database associated with the corresponding row and column value.

26. The method of claim 1 further comprising providing an interactive map of the container terminal accessible via the user interface, the interactive map including the graphical representation of:
(a) the formation of the storage locations across the container terminal, the storage locations selectable for assigning a storage location to a shipping container; and
(b) at the respective storage locations, the shipping containers that are selectable for ordering a shipping container to be moved from the current storage location thereof to the staging location and ordering a shipping container to be moved from the current storage location thereof to a new storage location.

27. The method of claim 1 wherein, the verification device comprises a computing device such as a smartphone, phablet, tablet PC, etc.

28. The method of claim 1 further comprising listing a plurality of interim entries within a staging database wherein, an interim entry represents a shipping container currently within the staging location slated for departure therefrom; the shipping container represented by the identification code thereof; the staging location database disposed in operative communication with the storage location database.

29. The method of claim 1 wherein, the scanner comprises a camera.

30. A computer-implemented method for managing a container terminal, comprising:
(a) generating a unique, machine-readable, identification code for each shipping container that arrives at the container terminal, the identification code comprising the details of the corresponding shipping container that are received via a user interface, each identification code imprinted on an identification tag that is adapted to be affixed to the corresponding shipping container thereof thereby registering the corresponding shipping container therewith, a registered shipping container initially moved to a staging location defined by a plurality of GPS coordinates that fall within the area thereof;
(b) listing a plurality of storage location entries within a storage location database wherein, a storage location entry represents a shipping container storage location within the container terminal, each storage location entry associated with one or more GPS coordinates that fall within the corresponding storage location area, and a container number entry, which represents the number of shipping containers stacked at the corresponding storage location, the number of shipping containers ranging from zero to n where, ‘n’ represents a predetermined maximum number of containers that can be stacked at a storage location, the storage locations associated container number entries comprising zero referred to as vacant storage locations, the storage locations associated container number entries comprising one to n referred to as occupied storage locations, each storage location entry further associated with one to n container level entries, viz., first container level entry, second container level entry, so on and so forth up to nth container level entry wherein, the first container level entry represents the identification code pertaining to the first-from-bottom shipping container at the corresponding storage location, the second container level entry represents the identification code pertaining to the second-from-bottom shipping container at the corresponding storage location, so on and so forth up to the nth container level entry representing the identification code pertaining to the nth-from-bottom or the first-from-top shipping container at the corresponding storage location, a container level entry not being occupied by a shipping container represented accordingly by zero, nil, etc.;
(c) listing a plurality of interim entries within a staging database wherein, an interim entry represents a shipping container currently within the staging location slated for departure therefrom; the shipping container represented by the identification code thereof; the staging location database disposed in operative communication with the storage location database;
(d) ordering, via the user interface, a shipping container to be moved from the staging location to a storage location, from the current storage location thereof to the staging location, or from the current storage location thereof to a new storage location, the shipping container represented by the identification code thereof;
(e) scanning, via a handheld verification device, the identification code on a shipping container moved to a storage location assigned thereto or the staging location, the code scanned at the storage or staging location;
(f) receiving the GPS coordinates of the handheld verification device during the scanning; and
(g) upon on the match between the GPS coordinates received by the GPS Receiver and the GPS coordinates of the storage or staging locations, i.e., upon successful verification, updating the appropriate container number entries and the container level entries within the storage location database and the interim entries within the staging location database accordingly.
